(19) United States
(12) Patent Application Publication
(10) Pub. No.: US 2026/0239383 A1
(43) Pub. Date: Aug. 13, 2026

(54) PSFCH PRIORITIZATION

(71) Applicant: INTERDIGITAL PATENT HOLDINGS, INC., Wilmington, DE (US)

(72) Inventors: Tuong Hoang, Montreal (CA); Tao Deng, New York, NY (US); Aata El Hamss, Laval (CA); Martino Freda, Laval (CA); Moon IL Lee, Melville, NY (US)

(73) Assignee: INTERDIGITAL PATENT HOLDINGS, INC., Wilmington, DE (US)

(21) Appl. No.: 19/155,288

(22) PCT Filed: Feb. 14, 2024
(86) PCT No.: PCT/US2024/015684

§ 371 Date: Aug. 11, 2025

Related U.S. Application Data
(60) Provisional application No. 63/445,665, filed on Feb. 14, 2023.

(51) Int. Cl. H04W 72/25; H04W 72/543; H04W 72/563

(52) U.S. Cl. CPC H04W 72/25; H04W 72/543; H04W 72/563

(57) ABSTRACT

One or more method/devices/systems are disclosed herein that address problems that arise out of sending feedback in sidelink and/or between devices operating in unlicensed spectrum. For example, in some cases, a first device may need to send a transmission to a second device. The first device may be configured with information such that the first device can determine the necessary parameters to send the transmission using the configured information. In an example, the first device may determine to prioritize one or more instances of feedback.

### CROSS-REFERENCE TO RELATED APPLICATIONS

This application claims the benefit of U.S. Provisional Application No. 63/445,665, filed Feb. 14, 2023, the contents of which are incorporated herein by reference.

### BACKGROUND

Generally, in the field of wireless communication, there may be one or more bands in which a device may transmit and receive messages and/or signals. In some instance, one or more of these bands may or may not be a licensed portion of spectrum, and/or one or more of these bands may need to be shared.

### SUMMARY

One or more method/devices/systems are disclosed herein that address problems that arise out of sending feedback in sidelink and/or between devices operating in unlicensed spectrum. For example, in some cases, a first device may need to send a transmission to a second device. The first device may be configured with information such that the first device can determine the necessary parameters to send the transmission using the configured information. In an example, the first device may determine to prioritize one or more instances of feedback.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of where a Tx WTRU requests the Rx WTRU to feedback using single-channel or multi-channel PSFCH;

FIG. 3 illustrates an example of PSFCH prioritization;

FIG. 4 illustrates an example of a WTRU determining whether transmit S-SSB; and

FIG. 5 illustrates an example method according to one or more techniques described herein.

### DETAILED DESCRIPTION

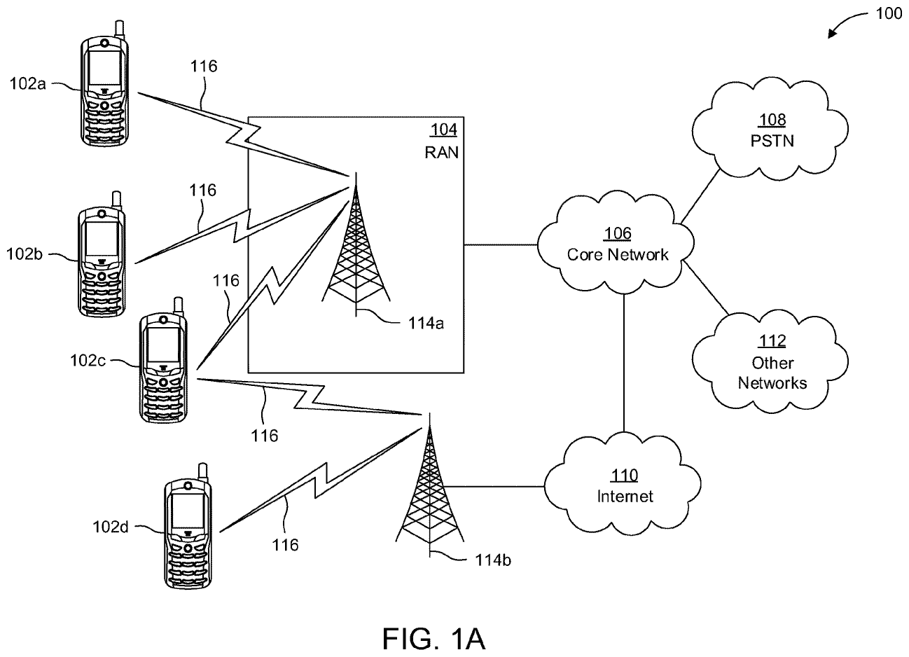

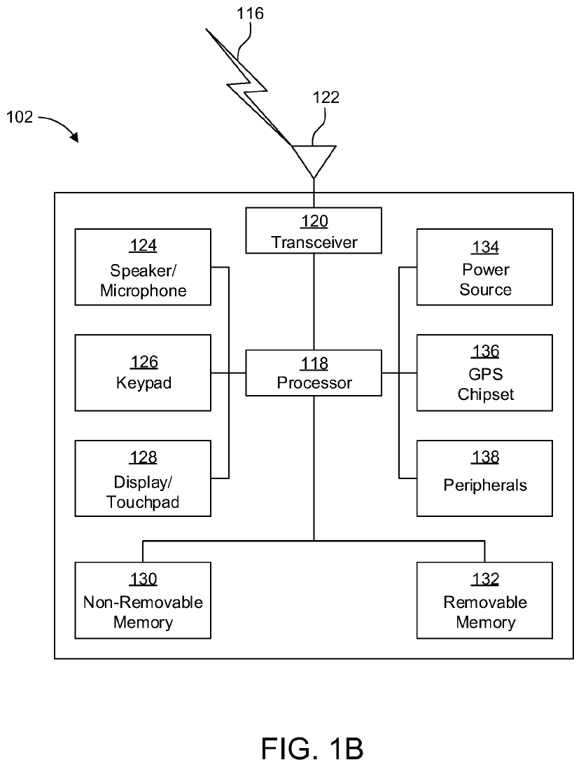

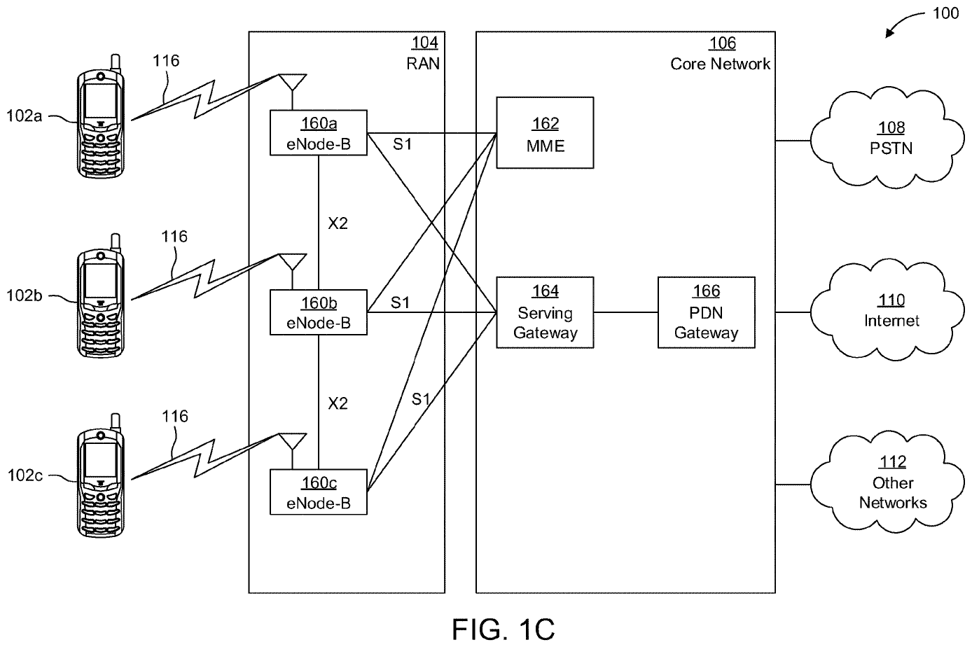

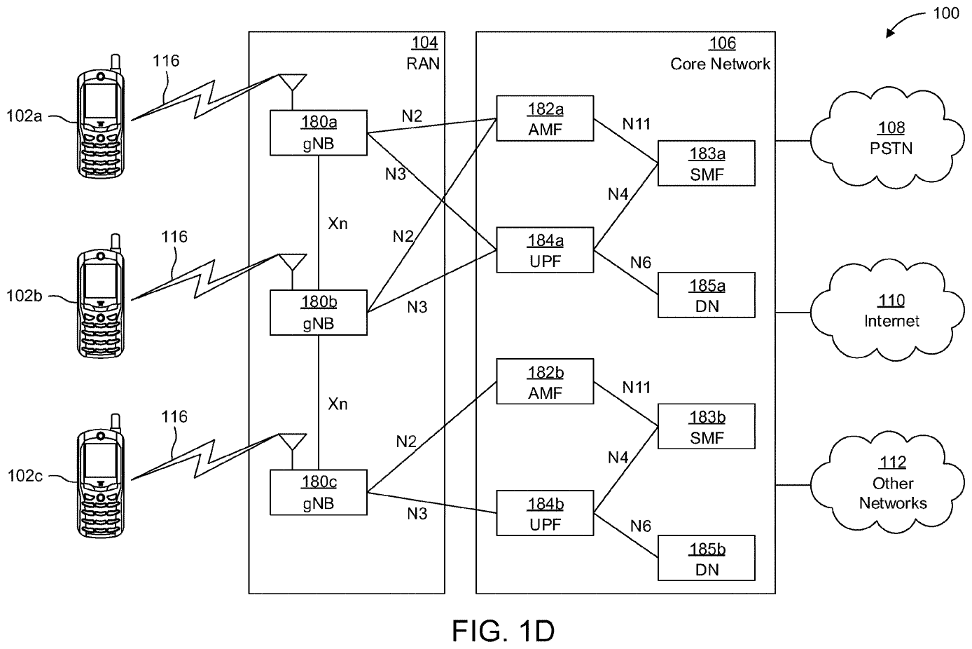

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VolP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANS, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUS 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUS 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In unlicensed spectrum, a bandwidth for one LBT sub-band may be 20 MHz. Wideband operation in unlicensed spectrum may be used to refer to the operation of a node having bandwidth larger than 20 MHz (e.g., multiple RB-sets, multi-channels). Wideband operation may help the WTRU obtain larger bandwidth and achieve higher throughput.

In some cases, NR Uu may support two types of base station channel access for wideband operation, such as are type A and type B wideband channel access. In type A, the base station may maintain individual LBT process for each LBT sub-band and it may perform transmission in each LBT sub-band if LBT is successful. In type B, the base station may select one LBT sub-band (cj) for Type-1 LBT and the remaining LBT sub-bands for Type-2 LBT (e.g., sensing T_{mc}=25 us before Tx in LBT sub-band cj). The base station may transmit in LBT sub-band cj and any Type-2 LBT success LBT sub-band ci.

For UL operation, a WTRU may be scheduled for a wideband PUSCH, and it may transmit the PUSCH if LBT is successful in all scheduled LBT sub-bands. Such a restriction may help the network to avoid blind detection of the transmission from the WTRU due to the unpredictable LBT result.

In some cases, regarding control signaling (e.g., S-SSB, SCI, PSFCH, etc.) for wideband operation in unlicensed SL operation, a PSFCH, located at the end of a slot, may be (pre-)configured in a resource pool. A resource pool may be (pre-)configured with the periodicity of a PSFCH every 1, 2, or 4 slots. A one-to-one mapping between PSCCH/PSSCH and PSFCH may be supported, in which the Rx WTRU knows the location and the resource for PSFCH upon reception of a PSCCH/PSSCH. It may be expected that, in unlicensed SL operation, PSFCH may also be supported, however, to deal with potential LBT failure for PSFCH, some enhancements may be needed. For example, the Tx WTRU may dynamically indicate the PSFCH occasion or one PSCCH/PSSCH may have multiple associated PSFCH occasions, which can be within the RB set or in another RB-set.

For unlicensed operation, channel occupancy time (COT) sharing between two WTRUs may be supported, in which the WTRU can continue using the COT of another WTRU to transmit PSFCH and/or PSCCH/PSSCH. To maintain a multi-channel COT, WTRUs involved in the COT maintenance may need to contiguously transmit signals in all RB-sets during the COT duration. The maximum allowable interruption time between two transmissions may be preconfigured value (e.g., 25 us). Accordingly, it may be necessary for a WTRU to transmit a signal (e.g., as described herein) to maintain a COT.

Regarding S-SSB(s), S-SSB occasion(s) may be (pre-)configured in a resource pool. The WTRU may be required to perform LBT before transmission of S-SSB. If the WTRU transmits S-SSB(s) only, it may need to perform type 2 LBT. However, when the WTRU initiates a COT, the COT may be maintained by transmitting S-SSB(s) or any other type of transmission.

A WTRU may be (pre-)configured with two set of S-SSB occasions, in which one set of occasions (e.g., S-SSBs) is excluded from any resource pool. The remaining S-SSB occasions (e.g., S-SSBs) may or may not be excluded from a resource pool.

In unlicensed sidelink operation, S-SSB and/or PSFCH may be used for control signals (e.g., as described herein), which may help the sidelink system operate properly and efficiently. For wideband operation, it may be important to design procedures to access the channel and transmit control signals such as S-SSB and/or PSFCH to support the system using unlicensed spectrum efficiently and fairly. Accordingly, there is a need for one or more procedures/devices/systems for control signal transmissions including PSFCH and/or S-SSB in multi-channel operation in sidelink unlicensed. From the above, it may be understood that control signaling may refer to S-SSB and/or feedback (PSFCH transmission) and/or control information transmissions; further, discussions on control signaling may be applicable to all type of control signaling, even though only one type of control signaling may be discussed in a given example.

As discussed herein, channel, RB-set, and LBT sub-band may be used interchangeably. As described herein, (pre-)configured may be equivalent to preconfigured, which may also be equivalent to receiving configuration from the network (e.g., via NAS, RRC or SIB). Multi-channel PSFCH may be used to describe the case that the WTRU provides feedback to a PSCCH/PSSCH using multiple channels. In one solution, the WTRU may transmit one PSFCH in one channel and repeat the same feedback in other channels. In another solution, the WTRU may transmit one PSFCH spanning over multiple channels. Short CCA may be used to describe any LBT scheme, which requires the WTRU to perform short sensing of the channel before transmission. Such short CCA may be used for the WTRU to share a COT or to transmit a short control signaling. Examples of short CCA may be any LBT type 2 schemes, such as LBT type 2A, LBT type 2B, and LBT type 2C. Long CCA may be used to describe any LBT scheme, which requires the WTRU to perform a longer sensing, which may be required for the WTRU to initiate a COT. Example of long CCA may be any LBT type 1 scheme.

In some cases, a HARQ may be performed using multi-channel HARQ. In one case, a WTRU may determine the set of parameters to access the channel and transmit PSFCH. A WTRU may determine to transmit PSFCH to feedback a PSCCH/PSSCH. The set of parameters to access the channel and transmit PSFCH may include one or any combination of the following: the set of RB-sets to transmit PSFCH; whether the PSFCH is transmitted in multi-channels or a single-channel; how many RB-sets to transmit PSFCH; the Clear Channel Access (CCA) duration; LBT type for each RB-set and all RB-sets to transmit PSFCH; LBT type for multi-channel access (e.g., LBT type A, A1, A2,B, B1, B2); whether the WTRU performs short CCA for each RB-set (e.g., LBT type 2-like channel access procedure) or it performs long CCA (e.g., LBT type 1-like channel access procedure); LBT type for one LBT RB-set channel access (e.g., LBT type 1, 2, 2A, 2B, 2C); the channel access priority class (CAPC); CPE used for PSFCH transmission; Contention window size, which may include the current contention window (CWₚ), the minimum, and/or the maximum contention window associated with the channel access priority class p (e.g., CWₚ, CW_{min,p}, and CW_{max,p}); the defer period (T_{d}); the LBT energy detection threshold to determine the availability of a channel; and/or, transmission power of PSFCH.

In one case, a WTRU may transmit PSFCH in multiple channels (multi-channel) to feedback a PSCCH/PSSCH. A WTRU may transmit multi-channel PSFCH to feedback a multi-channel PSCCH/PSSCH. The WTRU may determine the frequency resources of PSFCH in each RB-set based on the PSCCH/PSSCH in each RB-set and the (pre-)configured mapping between PSCCH/PSSCH and PSFCH in each RB-set. The WTRU may then determine whether to feedback ACK/NACK for the received PSCCH/PSSCH. In one approach, the WTRU may then generate PSFCH in each RB-set and transmit the same information (e.g., ACK or NACK) in each RB-set by simultaneously transmits multiple PSFCHs in multiple RB-sets. In another approach, the WTRU may transmit one PSFCH spanning over multiple RB-sets.

In one case, a WTRU may determine the parameters of its COT. A WTRU may initiate a COT for its transmission and potentially share the COT with another node (e.g., other WTRU or base station). The WTRU may then indicate one or more parameters for the COT in one or more PSCCH/PSSCH transmission(s) in the COT. The parameters for the COT may include one or more of the following: the set of RB-sets for PSCCH/PSSCH transmission in the COT; the maximum COT duration; the transmission duration of the WTRU in the COT; the remaining duration of the COT, which may be used for other WTRU to share the COT; the set of PSFCH occasions in the COT, which may be in the middle of the COT or at the end of the COT.

One or more parameters for one COT of the Tx WTRU may be determined based on one or more conditions. For example, one condition may be the buffer status of the WTRU (e.g., the amount of data in the buffer). In one instance, if the buffer status of the WTRU is greater than a (pre-)configured threshold, the WTRU may initiate a multi-channel COT; otherwise, the WTRU may initiate a single-channel COT. In another instance, the WTRU may be (pre-)configured with multiple buffer status thresholds, in which each buffer status threshold may be associated with the maximum number of RB-sets and/or maximum bandwidth of a COT the WTRU can initiate. The WTRU may then determine the number of RB-sets and/or bandwidth to initiate the COT based on its buffer status and the maximum bandwidth associated with its buffer status.

For example, one condition may be the QoS (e.g., priority, latency, reliability, and remaining PDB of the data in the buffer). In one instance, the WTRU may be (pre-)configured with a maximum bandwidth COT as a function of the amount of data and the QoS (e.g., latency requirement) associated with the data. The WTRU may then determine the number of RB-sets to initiate a COT based on both QoS of the data and the amount of data in the buffer. For example, for the same amount of data, the WTRU may initiate a multi-channel COT if the latency requirement is small; otherwise, if the latency requirement is larger, the WTRU may initiate a single-channel COT.

For example, one condition may be the CBR of the resource pool. For instance, the WTRU may be (pre-)configured with a maximum number of COTs or maximum COT duration to reserve based on the CBR of the resource pool.

For example, one condition may be the CR of the WTRU. For instance, the WTRU may reserve a short COT if CR of the WTRU is larger than a (pre-)configured threshold; otherwise, the WTRU may reserve a long COT.

In one case, a WTRU may determine the type of PSFCH occasions to transmit feedback.

A WTRU may determine one or more of types of PSFCH occasions to transmit feedback for a PSCCH/PSSCH. For example, one type of occasion may be where the PSFCHs are in (pre-)configured PSFCH occasions in the resource pool. In one instance, the WTRU may be (pre-)configured with PSFCH occasions in the resource pool, in which the WTRU may be required to perform a short CCA (e.g., type 2 LBT) to access the channel. In another instance, the WTRU may be (pre-)configured with PSFCH occasions in the resource pool, in which the WTRU may be required to perform a long CCA (e.g., type 1-like LBT).

For example, one type of occasion may be where the PSFCHs are in the COT of the Tx WTRU. For instance, the Tx WTRU may initiate the COT, the WTRU may then indicate one or more PSFCH in its COT, which may be in the middle of the COT or at the end of the COT. The Rx WTRU may then be required to perform short CCA (e.g., type 2 LBT) to access the channel and transmit PSFCH.

For example, one type of occasion may be where the PSFCHs in the COT of the Rx WTRU. For instance, the Rx WTRU may initiate its COT and transmit PSFCH. The PSFCH occasion may be at the beginning of the COT, in the middle of the COT, and/or at the end of the COT.

A WTRU (e.g., Tx WTRU, Rx WTRU of the PSCCH/PSSCH) may determine the PSFCH occasion(s) for a PSCCH/PSSCH based on one or more factors, such as the QoS of the TB and/or the buffer status of the WTRU.

For the QoS of the TB, in one example, if the latency of the TB is larger than a (pre-)configured threshold, the Tx WTRU may request HARQ feedback in a (pre-)configured PSFCH occasion, which may be outside of the COT of the Tx WTRU. Otherwise, if the latency of the TB is smaller than the threshold, the Tx WTRU may request HARQ feedback in a PSFCH occasion within the COT of the Tx WTRU (e.g., in the middle of the COT or at the end of the COT). In another example, if the priority/reliability of the TB is larger than a (pre-)configured threshold, the Tx WTRU may request HARQ feedback in a PSFCH occasion which requires the WTRU to perform short CCA (e.g., type 2 LBT) or no CCA. Alternatively, if the priority/reliability of the TB is smaller than the threshold, the WTRU may request HARQ feedback in a PSFCH occasion requiring the WTRU to perform long CCA (e.g., type 1 LBT).

For the buffer status of the WTRU, in one example, if the amount of the data in the buffer is larger than a threshold, the WTRU may request HARQ feedback within its COT. Otherwise, the WTRU may request HARQ feedback in a PSFCH occasion outside of its COT (e.g., in a (pre-)configured PSFCH occasion or in a COT initiated by the Rx WTRU).

In some cases, there may be one or more methods for requesting HARQ feedback. In one case, a WTRU may determine one or more parameters in a set of parameters to access the channel and Tx PSFCH. In one approach, a WTRU (e.g., Tx WTRU) may determine one or more parameters in the set of parameters (e.g., the set of RB-sets to transmit PSFCH, whether the PSFCH is transmitted in multi-channels or a single-channel, how many RB-sets to transmit PSFCH, the CCA duration, the LBT for each RB-set and all RB-set, LBT type for multi-channel access, contention window size, CAPC, CPE, CW, LBT energy detection, transmission power, etc.) for the Rx WTRU to access the channel and transmit PSFCH in one PSFCH occasion for its PSCCH/PSSCH transmission. The Tx WTRU may then indicate one or more determined parameters to the Rx WTRU. The indicated parameters may be in the SCI (e.g., the first SCI or the second SCI) or MAC CE of the PSCCH/PSSCH transmission. One or more parameters in the set of parameters to access the channel and transmit PSFCH may be determined based on one or more conditions.

For instance, one condition to determine one or more parameters (e.g., for channel access, control signaling, PSFCH, etc.) may be whether the WTRU indicates and/or reserves one or more resources in the COT for its PSCCH/PSSCH transmission after the PSFCH occasion. For example, if the WTRU indicates and/or reserves one or more resources in the COT for its PSCCH/PSSCH transmission after the PSFCH occasion, the WTRU may request the Rx WTRU to transmit multi-channel PSFCH. Otherwise, if the WTRU does not indicate/reserve resources after PSFCH occasion, the WTRU may request the Rx WTRU to transmit either single-channel or multi-channel PSFCH. This approach may be motivated to help the WTRU maintains the COT for its further transmission after the PSFCH occasions.

For instance, one condition to determine one or more parameters (e.g., for channel access, control signaling, PSFCH, etc.) may be the location of the PSFCH occasion with respect to the COT of the Tx WTRU. For example, the WTRU may request the Rx WTRU to transmit multi-channel PSFCH if the PSFCH occasion is in the middle of the COT. Alternatively, if the PSFCH occasion is at the end of the COT, in one approach, the WTRU may request the Rx WTRU to transmit PSFCH in one RB-set. The WTRU may determine which RB-set to request the Rx WTRU based on the (pre-)configured rule, which may be exchanged between the transmitter and receiver (e.g., via PC5 RRC message). In another approach, the WTRU may request the Rx WTRU to transmit in either single-channel or multi-channels.

For instance, one condition to determine one or more parameters (e.g., for channel access, control signaling, PSFCH, etc.) may be whether the WTRU continues to use the COT after the PSFCH occasion. For example, the WTRU may request the Rx WTRU to transmit multi-channel PSFCH if the WTRU determines to continue using the COT for PSCCH/PSSCH transmission after the PSFCH occasion. Otherwise, if the WTRU decides not to perform PSCCH/PSSCH transmission after the PSFCH occasion, the WTRU may request the Rx WTRU to transmit either single-channel or multi-channel PSFCH.

For instance, one condition to determine one or more parameters (e.g., for channel access, control signaling, PSFCH, etc.) may be the QoS (e.g., priority, latency, reliability, minimum communication range, remaining PDB) of the TB. In one example, the Tx WTRU may request the Rx WTRU to transmit multi-channel PSFCH if the priority of the TB is greater than a (pre-)configured threshold; otherwise, the WTRU may request the Rx WTRU to transmit single-channel PSFCH. In another example, the Tx WTRU may request the Rx WTRU to use a first CPE if the priority of the TB is greater than a (pre-)configured threshold; otherwise, if the priority of the TB is smaller than the threshold, the Tx WTRU may request the Rx to use a second CPE, which may be shorter than the first CPE. Alternatively, if the priority of the TB is smaller than the threshold, the Tx WTRU may request the Rx WTRU not to use CPE to transmit PSFCH.

For instance, one condition to determine one or more parameters (e.g., for channel access, control signaling, PSFCH, etc.) may be the CBR of the resource pool. In one example, the Tx WTRU may request the Rx WTRU to transmit multi-channel PSFCH if the CBR of the resource pool is smaller than a (pre-)configured threshold; otherwise, if the CBR of the resource pool is larger than the threshold, the WTRU may request the Rx WTRU to transmit single-channel PSFCH. In another example, the WTRU may be (pre-)configured with the maximum number of RB-sets to transmit PSFCH based on the CBR of the resource pool. The Tx WTRU may then determine the number of RB-sets to request the Rx WTRU to transmit PSFCH based on the CBR of the resource pool. The set of RB-sets to feedback PSFCH may be the set of lowest RB-set indexes or the set of the highest RB-set indexes.

For instance, one condition to determine one or more parameters (e.g., for channel access, control signaling, PSFCH, etc.) may be the lowest/highest RB-set index of PSCCH/PSSCH. For example, the Tx WTRU may request the Rx WTRU to transmit a single-channel PSFCH to feedback a PSCCH/PSSCH (e.g., a multi-channel PSFCH). The Tx WTRU may request the Rx WTRU feedback in the lowest or the highest RB-set index out of the RB-sets used to transmit PSCCH/PSSCH.

For instance, one condition to determine one or more parameters (e.g., for channel access, control signaling, PSFCH, etc.) may be the set of RB-sets used to transmit PSCCH/PSSCH. For example, if the WTRU transmits PSCCH/PSSCH in two or more contiguous RB-sets, the Tx WTRU may request the Rx WTRU to give feedback using multi-channel PSFCH in the set of associated RB-sets for PSCCH/PSSCH. However, if the WTRU transmits PSCCH/PSSCH in two non-contiguous RB-sets, the Tx WTRU may request the Rx WTRU to feedback PSFCH in one RB-set. The RB-set used to feedback PSFCH may be the lowest or the highest RB-set index.

For instance, one condition to determine one or more parameters (e.g., for channel access, control signaling, PSFCH, etc.) may be a number of HARQ feedback bits. For example, the Tx WTRU may request the Rx WTRU to transmit multi-channel PSFCH if the number of HARQ feedback bits is larger than a (pre-)configured threshold; otherwise, if the number of HARQ feedback bits is smaller than the threshold, the Tx WTRU may request the Rx WTRU to transmit single-channel PSFCH.

For instance, one condition to determine one or more parameters (e.g., for channel access, control signaling, PSFCH, etc.) may be PSFCH format. For example, the Tx WTRU may request the Rx WTRU to transmit single-channel PSFCH if the Rx WTRU uses the first PSFCH format (e.g., single bit PSFCH format); otherwise, the Tx WTRU may request the Rx WTRU to transmit multi-channel PSFCH to feedback the PSCCH/PSSCH if the Rx WTRU uses the second PSFCH format (e.g., multi-bits PSFCH format). For example, the WTRU may use the first CPE if the WTRU uses the first PSFCH format (e.g., single bit PSFCH format); otherwise, the WTRU may use the second CPE (e.g., which is longer than the first CPE) if the WTRU uses the second PSFCH format (e.g., multi-bits PSFCH format).

For instance, one condition to determine one or more parameters (e.g., for channel access, control signaling, PSFCH, etc.) may be the type of PSFCH occasion. For example, the Tx WTRU may request the Rx WTRU to give feedback using multi-channel PSFCH if the PSFCH occasion is in the middle of its COT. Alternatively, if the PSFCH is in one (pre-)configured occasion (e.g., such occasion may require the WTRU to perform type 1 LBT or type 2 LBT), the Tx WTRU may request the Rx WTRU to feedback using single-band PSFCH.

For instance, one condition to determine one or more parameters (e.g., for channel access, control signaling, PSFCH, etc.) may be an indication from another node. In one example, a WTRU (e.g., the WTRU different from the PSFCH Tx and Rx WTRUs) may reserve one or more resources after an PSFCH occasion in a set of RB-sets. The Tx WTRU may then request the Rx WTRU to transmit PSFCH in the set of RB-sets having the reserved resources. In another example, the Tx WTRU may receive the scheduling of the PSFCH occasion to feedback its PSCCH/PSSCH from base station. The WTRU may then forward the scheduling decision to the Rx WTRU to request the Rx WTRU to transmit PSFCH in the scheduled PSFCH occasion by the network.

In one case, a Tx WTRU may send one or more PSCCH/PSSCH transmission(s) after requesting feedback using multi-channel PSFCH within the COT. A Tx WTRU may determine to transmit PSCCH/PSSCH after requesting the Rx WTRU to feedback using multi-channel PSFCH in the middle of the COT. Specifically, the WTRU may perform retransmission of TB and/or perform initial transmission and/or retransmission of one or more new TBs until the PSFCH occasion.

In one case, the WTRU may determine whether to continue using the COT after an PSFCH occasion within the COT. The WTRU may monitor a PSFCH occasion to determine the decoding status of its PSCCH/PSSCH. The WTRU may then determine whether to continue using the COT after the PSFCH occasion based on the availability of the PSFCH transmission. Specifically, if the WTRU detects PSFCH in all RB-sets of the associated PSCCH/PSSCH, the WTRU may continue use the COT after the PSFCH occasion. The WTRU may perform a short CCA (e.g., type 2 LBT) in the set of RB-sets to continue using the COT.

In one case, there may be a specific WTRU behavior if multi-channel PSFCH is not detected. In one approach, the WTRU may not be able to detect PSFCH in all RB-sets associated with PSCCH/PSSCH transmission. The WTRU may perform one or more action.

For instance, one action may be to stop using the COT. For example, if PSFCH in all RB-sets associated with PSCCH/PSSCH is not detected, the WTRU may stop using the COT. The WTRU may initiate another COT to perform further PSCCH/PSSCH transmission.

For instance, one action may be to perform (e.g., send) PSCCH/PSSCH transmission in the set or subset of RB-sets having PSFCH detected. In one approach, the WTRU may perform PSCCH/PSSCH transmission in one RB-sets from the set RB-sets having PSFCH detected. In another approach, the WTRU may perform PSCCH/PSSCH transmission in a set of contiguous RB-sets having PSFCH detected.

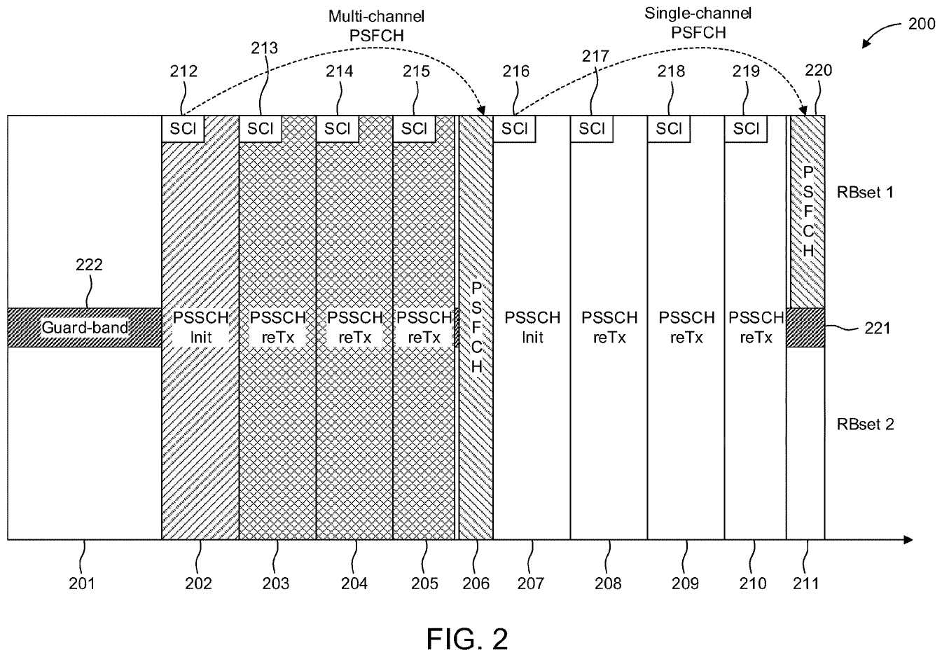

FIG. 2 illustrates an example of where a Tx WTRU requests the Rx WTRU to feedback using single-channel or multi-channel PSFCH. As shown, time is on the horizontal axis and frequency is on the vertical axis. In the example shown in FIG. 2, the Tx WTRU may initiate a two RB-set COT with the COT duration of 8 slots based on the buffer status of the Tx WTRU and the QoS of the data in the buffer. There may be two PSFCH occasions in the COT, which are the PSFCH at the end of the fourth slot (e.g., 206) and the eighth slot (e.g., 211). The Tx WTRU may determine to continue the COT after the fourth PSFCH occasion and the Tx WTRU may determine to stop the COT after the eighth transmission. The Tx WTRU may determine to perform an initial transmission of the first TB (e.g., 202) and request the Rx WTRU to feedback multi-channel PSFCH in the PSFCH occasion at the end of the fourth slot (e.g., 206); the message informing the Rx WTRU of the PSFCH may be in the SCI of one or more of the (re)transmissions. The Tx WTRU may then perform retransmissions for the TB until the fourth slot (e.g., 203, 204, and/or 205). After the PSFCH occasion (e.g., 206), the Tx WTRU may transmit the second TB (e.g., 207) and request the Rx WTRU to transmit PSFCH in single-channel PSFCH (e.g., 220); the message informing the Rx WTRU of the PSFCH may be in the SCI of one or more of the (re)transmissions. The Tx WTRU may then perform retransmissions of the second TB until slot eighth of the COT (e.g., 207, 208, 209, 210). As can be understood from the figure, in one or more of the transmissions there may be control information sent with and/or before a TB transmission or retransmission (e.g., as further discussed herein); note, there may be a guard band 222 for one or more of the transmissions (e.g., to prevent interference, as required, etc.).

In some cases, there may one or more methods for transmitting HARQ feedback. In one case a WTRU may determine a parameter(s) in a set of parameters to access the channel and send a PSFCH transmission. In an approach, a WTRU (e.g., Rx WTRU) may determine one or more parameters in the set of parameters (e.g., the set of RB-sets to transmit PSFCH, whether the PSFCH is transmitted in multi-channels or a single-channel, how many RB-sets to transmit PSFCH, the CCA duration, the LBT for each RB-set and all RB-set, LBT type for multi-channel access, contention window size, CAPC, CPE, CW, LBT energy detection, transmission power, etc.) to access the channel and transmit PSFCH in one PSFCH occasion. One or more parameters in the set of parameters to access the channel and transmit PSFCH may be determined based on one or more conditions/factors.

For instance, the one or more parameters (e.g., for channel access, control signaling, PSFCH, etc.) may be determined based on whether the Rx WTRU shares the COT with the Tx WTRU to transmit multi-channel PSCCH/PSSCH. For example, if the Rx WTRU determines to share the multi-channel COT with the Tx WTRU, the WTRU may transmit multi-channel PSFCH to maintain the COT. The WTRU may perform a short CCA (e.g., type 2 LBT) before transmission of the PSFCH. The WTRU may then continue using the COT to transmit PSCCH/PSSCH. Otherwise, if the WTRU does not share the COT with the Tx WTRU, in one approach, the WTRU may initiate a multi-channel COT and transmit multi-channel PSFCH and multi-channel PSCCH/PSSCH. Alternatively, the WTRU may initiate a single-channel COT and transmit single-channel PSFCH and single-channel PSCCH/PSSCH. The set of occasions (e.g., PSFCH occasion) to initiate the COT may be indicated by the Tx WTRU or (pre-)configured in the resource pool. Specifically, the Tx may indicate the set of PSFCH occasions for the Rx WTRU to initiate the COT and transmit PSFCH. The WTRU may then perform type 1 LBT in one or more of the indicated occasions to transmit PSFCH and PSCCH/PSSCH in its COT.

For instance, the one or more parameters (e.g., for channel access, control signaling, PSFCH, etc.) may be determined based on whether the RX WTRU shares the COT with the Tx WTRU to transmit single-channel PSCCH/PSSCH. For example, if the Rx WTRU determines to share one RB-set with the Tx WTRU, the Rx WTRU may transmit single-channel PSFCH in an PSFCH occasion in the middle of the COT. The WTRU may then continue using the COT to transmit PSCCH/PSSCH in the RB-set used to transmit PSFCH. For example, if the Rx WTRU determines to share one RB-set with the Tx WTRU, the Rx WTRU may transmit single-channel PSFCH in an PSFCH occasion in the middle of the COT. The WTRU may then continue using the COT to transmit PSCCH/PSSCH in the RB-set used to transmit PSFCH.

For instance, the one or more parameters (e.g., for channel access, control signaling, PSFCH, etc.) may be determined based on the buffer status of the Rx WTRU. In one example, if the buffer status of the WTRU is greater than a (pre-)configured threshold, the WTRU may transmit multi-channel PSFCH to share the multi-channel COT of the Tx WTRU. The WTRU then continues using the COT to transmit PSCCH/PSSCH. Otherwise, if the buffer status of the WTRU is smaller than the threshold, the WTRU may share the COT with the WTRU using one of the RB-sets to transmit single-channel PSFCH. In another example, if the buffer status of the WTRU is greater than a (pre-)configured threshold, the WTRU may transmit multi-channel PSFCH to initiate a multi-channel. The WTRU may transmit multi-channel in the initiated COT. The WTRU may then continue using the COT to transmit PSCCH/PSSCH. Otherwise, if the buffer status of the WTRU is smaller than a (pre-)configured threshold, the WTRU may first determine an RB-set to initiate a COT. The WTRU may initiate a single-channel COT to transmit single-channel PSFCH. The WTRU may then continue using the COT to transmit PSCCH/PSSCH.

For instance, the one or more parameters (e.g., for channel access, control signaling, PSFCH, etc.) may be determined based on the set of RB-sets the Rx WTRU determines to transmit PSCCH/PSSCH after the PSFCH. For example, the WTRU may first determine the set of RB-sets to transmit PSCCH/PSSCH. The WTRU may then transmit PSFCH in the determined set of RB-sets for transmission of PSCCH/PSSCH.

For instance, the one or more parameters (e.g., for channel access, control signaling, PSFCH, etc.) may be determined based on the location of the PSFCH occasion with respect to the COT of the Tx WTRU. For example, the Rx WTRU may receive the COT information from the Tx WTRU. The Rx WTRU may transmit multi-channel PSFCH if the PSFCH occasion is in the middle of the transmission duration in the COT of the Tx WTRU. Alternatively, if the PSFCH occasion is at the end of the COT, in one approach, the Rx WTRU may transmit PSFCH in one RB-set. The WTRU may determine which RB-set to transmit based on the (pre-)configured rule, which may be exchanged between the transmitter and receiver (e.g., via PC5 RRC message). In another approach, the Rx WTRU may transmit PSFCH in either single-channel or multi-channels.

For instance, the one or more parameters (e.g., for channel access, control signaling, PSFCH, etc.) may be determined based on QoS of the TB. In one example, the Rx WTRU may transmit multi-channel PSFCH if the priority of the TB is greater than a (pre-)configured threshold; otherwise, the Rx WTRU transmit single-channel PSFCH. In another example, the Rx WTRU to use a first CPE if the priority of the TB is greater than a (pre-)configured threshold; otherwise, if the priority of the TB is smaller than the threshold, the Rx WTRU may use a second CPE, which may be shorter than the first CPE. Alternatively, if the priority of the TB is smaller than the threshold, the Rx WTRU may not use CPE to transmit PSFCH.

For instance, the one or more parameters (e.g., for channel access, control signaling, PSFCH, etc.) may be determined based on CBR of the resource pool. In one example, the Rx WTRU may transmit multi-channel PSFCH if the CBR of the resource pool is smaller than a (pre-)configured threshold; otherwise, if the CBR of the resource pool is larger than the threshold, the Rx WTRU may transmit single-channel PSFCH. In another example, the WTRU may be (pre-)configured with the maximum number of RB-sets to transmit PSFCH based on the CBR of the resource pool. The Rx WTRU may then determine the number of RB-sets to transmit PSFCH based on the CBR of the resource pool. The set of RB-sets to feedback PSFCH may be the set of lowest RB-set indexes or the set of the highest RB-set indexes.

For instance, the one or more parameters (e.g., for channel access, control signaling, PSFCH, etc.) may be determined based on the lowest/highest RB-set index of PSCCH/PSSCH. For example, the Rx WTRU may be (pre-)configured to transmit single-channel PSFCH to feedback a PSCCH/PSSCH (e.g., a multi-channel PSFCH). The WTRU may be (pre-)configured to feedback in the lowest or the highest RB-set index out of the RB-sets used to transmit PSCCH/PSSCH.

For instance, the one or more parameters (e.g., for channel access, control signaling, PSFCH, etc.) may be determined based on the result of the LBT procedure to transmit PSFCH. For example, the Rx WTRU may perform LBT in all RB-sets associated with PSCCH/PSSCH to transmit PSFCH. The WTRU may then transmit PSFCH in all LBT RB-sets associated with the PSCCH/PSSCH if LBT is successful. Otherwise, if the WTRU fails LBT in one of the RB-sets, the WTRU may transmit PSFCH in one RB-set with lowest/highest RB-set index or in a set of contiguous LBT succeed RB-sets.

For instance, the one or more parameters (e.g., for channel access, control signaling, PSFCH, etc.) may be determined based on the set of RB-sets used to transmit PSCCH/PSSCH. For example, if the Tx WTRU transmits PSCCH/PSSCH in two or more contiguous RB-sets, the Rx WTRU may transmit multi-channel PSFCH in the set of associated RB-sets for PSCCH/PSSCH to feedback the HARQ status of the PSCCH/PSSCH. However, if the Tx WTRU transmits PSCCH/PSSCH in two non-contiguous RB-sets, the Rx WTRU may determine to feedback PSFCH in one RB-set. The RB-set used to feedback PSFCH may be the lowest or the highest RB-set index.

For instance, the one or more parameters (e.g., for channel access, control signaling, PSFCH, etc.) may be determined based on the maximum PSFCH bandwidth. For example, the Rx WTRU may be (pre-)configured with a maximum PSFCH bandwidth to feedback a PSCCH/PSSCH. The WTRU may then determine the number of RB-sets to feedback PSFCH to satisfy the (pre-)configured maximum bandwidth.

For instance, the one or more parameters may be determined based on a number of HARQ feedback bits. For example, the Rx WTRU may transmit multi-channel PSFCH if the number of HARQ feedback bits is larger than a (pre-)configured threshold; otherwise, if the number of HARQ feedback bits is smaller than the threshold, the Rx WTRU may transmit single-channel PSFCH to feedback the PSCCH/PSSCH.

For instance, the one or more parameters (e.g., for channel access, control signaling, PSFCH, etc.) may be determined based on a PSFCH format. For example, the Rx WTRU may transmit single-channel PSFCH if the WTRU transmit the first PSFCH format (e.g., single bit PSFCH format); otherwise, the WTRU may transmit multi-channel PSFCH to feedback the PSCCH/PSSCH if the WTRU uses the second PSFCH format (e.g., multi-bits PSFCH format). For example, the WTRU may use the first CPE if the WTRU transmits the first PSFCH format (e.g., single bit PSFCH format); otherwise, the WTRU may use the second CPE (e.g., which is longer than the first CPE) if the WTRU transmits the second PSFCH format (e.g., multi-bits PSFCH format).

For instance, the one or more parameters (e.g., for channel access, control signaling, PSFCH, etc.) may be determined based on the type of PSFCH occasion. For example, the Tx WTRU may request the Rx WTRU to give feedback using multi-channel PSFCH if the PSFCH occasion is in the middle of its COT. Alternatively, if the PSFCH is in one (pre-)configured occasion (e.g., such occasion may require the WTRU to perform type 1 LBT or type 2 LBT), the Tx WTRU may request the Rx WTRU to feedback using single-band PSFCH.

For instance, the one or more parameters (e.g., for channel access, control signaling, PSFCH, etc.) may be determined based on indication from another node (e.g., the Tx WTRU). For example, the Tx WTRU may indicate to the Rx WTRU which parameters (e.g., LBT type, PSFCH occasions, bandwidth) to access the channel and transmit PSFCH. One or more parameters to access the channel and transmit PSFCH may be indicated via SCI. Other parameters may be indicated via PC5 RRC. For example, the WTRU may receive indication from the base station a set of parameters to access the channel and transmit PSFCH. One or more parameters to access the channel and transmit PSFCH may be indicated in DCI. Other parameters may be indicated by RRC or SIB. The Rx WTRU may then determine the parameters to access the channel and transmit PSFCH based on the indication from the base station or the Tx WTRU.

In some cases, there may be one or more methods for HARQ feedback for retransmission. In one case, a Tx WTRU may indicate multiple PSFCH occasions to feedback a PSCCH/PSSCH. The Tx WTRU may require multiple PSFCH occasions to feedback a PSCCH/PSSCH. In one approach, the Tx WTRU may determine one or more parameters in the set of parameters (e.g., the set of RB-sets to transmit PSFCH, whether the PSFCH is transmitted in multi-channels or a single-channel, how many RB-sets to transmit PSFCH, the CCA duration, the LBT for each RB-set and all RB-set, LBT type for multi-channel access, contention window size, CAPC, CPE, CW, LBT energy detection, transmission power, etc.) for the Rx WTRU to access the channel and transmit each PSFCH. The Tx WTRU may then indicate one or more determined parameters to the Rx WTRU. In another approach, the Rx WTRU may determine one or more parameters to access the channel and transmit each PSFCH. One or more parameters in the set of parameters to access the channel and transmit a subsequent PSFCH may be determined based on one or more conditions.

For instance, the one or more parameters (e.g., for channel access, control signaling, PSFCH, etc.) may be determined based on one or more parameters used to access the channel and transmit one or more previous PSFCH. In one example, the Tx WTRU may transmit PSCCH/PSSCH in two RB-sets (e.g., RB-set1 and RB-set2), the Rx WTRU may transmit the first PSFCH in one RB-set (e.g., RB-set 1) and it may transmit the second PSFCH in another RB-set (e.g., RB-set2).

For instance, the one or more parameters (e.g., for channel access, control signaling, PSFCH, etc.) may be determined based on a transmission status of the previous PSFCH (e.g., whether the previous PSFCH is transmitted). In one example, if the Rx WTRU successfully transmits PSFCH in the first PSFCH occasion, in one approach, the WTRU may stop transmitting PSFCH in the second occasion. In another approach, the WTRU may transmit PSFCHs in all indicate PSFCH occasions. In another approach, the WTRU may determine whether to transmit PSFCH in the second occasion based on one or more of the location of PSFCH in the COT (e.g., the WTRU continues to transmit PSFCH if the PSFCH is in the middle of the COT; otherwise, the WTRU may stop transmitting the PSFCH), whether the Tx/Rx WTRU continues using the COT (e.g., the WTRU may continue transmit the second PSFCH if the Tx/Rx WTRU continue using the COT after the PSFCH occasion; otherwise, the WTRU may not transmit the second PSFCH), the bandwidth of the PSCCH/PSSCH and/or the TB size (e.g., if the bandwidth and/or the TB size is greater than a (pre-)configured threshold, the WTRU may continue to transmit the second PSFCH; otherwise, the WTRU may not transmit the second PSFCH). In another example, if the WTRU fails to transmit in the first PSFCH occasion, the WTRU may change one or more parameters to access the and transmit PSFCH. Specifically, the WTRU may increase transmission power, change the set of RB-sets to transmit PSFCH, increase CPE, CAPC, change the LBT procedure (e.g., change to LBT type 2).

For instance, the one or more parameters (e.g., for channel access, control signaling, PSFCH, etc.) may be determined based on a decoding result of the TB. For example, if the WTRU successfully decodes the TB, the WTRU may stop transmitting the second PSFCH. Alternatively, the WTRU may stop transmitting the second PSFCH if the first PSFCH is transmitted; otherwise, if the first PSFCH is not transmitted, the WTRU may still transmit the second PSFCH. For example, if the WTRU fails to decode the TB, the WTRU may continue transmit the second PSFCH regardless of whether the first PSFCH is transmitted.

In one case, a WTRU may determine one or more parameters to access the channel and transmit feedback for retransmission of a TB. A WTRU (e.g., Tx WTRU or Rx WTRU) may determine one or more parameters to access the channel and transmit PSFCH to feedback a retransmission of a TB. One or more parameters in the set of parameters may be determined based on one or more conditions/factors.

For instance, the one or more parameters (e.g., for channel access, control signaling, PSFCH, etc.) may be determined based on one or more parameters used to access the channel and transmit PSFCH for the previous transmission of the TB (e.g., initial transmission of the TB). For example, the WTRU may change the set of RB-sets for the PSFCH to feedback for retransmission compared to the RB-sets for the PSFCH of the initial transmission.

For instance, the one or more parameters (e.g., for channel access, control signaling, PSFCH, etc.) may be determined based on transmission status of the PSFCH(s) for one or more previous transmissions of the TB. For example, if PSFCH is not transmitted to feedback the initial transmission of the TB, the WTRU may change the set of parameters to access the channel and transmit PSFCH for retransmission compared to the parameters to access the channel and transmit PSFCH for the initial transmission (e.g., the WTRU may switch the set of RB-set, increase transmission power, increase CAPC, priority of the PSFCH, etc.). For example, if PSFCH is transmitted to feedback the initial transmission of the TB, the WTRU may keep the set of parameters to access the channel and transmit PSFCH for retransmission compared to the parameters used for the PSFCH to feedback the initial transmission of the TB.

For instance, the one or more parameters (e.g., for channel access, control signaling, PSFCH, etc.) may be determined based on decoding result of the current or previous TB. For example, if the WTRU fails to decode the current or the previous TB, the WTRU may change the set of parameters to access the channel and transmit PSFCH for retransmission compared to the parameters to access the channel and transmit PSFCH for the initial transmission (e.g., the WTRU may switch the set of RB-set, increase transmission power, increase CAPC, priority of the PSFCH, etc.).

In one case, a WTRU may determine one or more parameters (e.g., for channel access, control signaling, PSFCH, etc.) to access the channel and transmit feedback for another TB. In one approach, a WTRU (e.g., Tx or Rx WTRU) may determine one or more parameters to access the channel and transmit PSFCH to feedback to one TB based on the parameters used to access the channel and transmit PSFCH of the previous TB, decoding status of the previous TB, and/or transmission status of the previous TB. For example, if the previous TB is received correctly and the PSFCH is transmitted, the Tx WTRU and/or the Rx WTRU may determine to use the same set of RB-sets to transmit PSFCH for the subsequent TB. Alternatively, if the previous TB is not received correctly and/or the PSFCH feedback is not transmitted, the WTRU may change one or more parameters to access the channel and transmit PSFCH (e.g., switch to a different set of RB-sets to transmit PSFCH, increase transmission power, increase CPE, increase energy detection threshold in LBT procedure, etc.).

In some cases, there may be one or more methods for PSFCH prioritization. In one case, a WTRU may determine the priority of each PSFCH based on the characteristics of the PSFCH. The WTRU may determine the priority of each PSFCH based on the characteristic of the PSFCH. Specifically, in one approach, the WTRU may be (pre-)configured with one priority for each characteristic of the PSFCH. In another approach, the WTRU may be (pre-)configured with a priority offset for each characteristic of the PSFCH. The WTRU may then determine the priority of the PSFCH based on the associated PSCCH/PSSCH and the (pre-)configured priority offset associated with the characteristic of the PSFCH. The characteristic of the PSFCH may include one or more indications.

For instance, the characteristic of the PSFCH may include whether the PSFCH is used to give feedback to the COT initiator in the PSFCH occasion within the COT. For example, the WTRU may be (pre-)configured with a priority offset if the PSFCH is used to feedback to the COT initiator; otherwise, no priority offset may be applied.

For instance, the characteristic of the PSFCH may include whether the PSFCH is used to maintaining a COT. For example, the WTRU may be (pre-)configured with a highest priority offset if the PSFCH is used to maintain the COT. The WTRU may then prioritize transmitting PSFCH the occasion to maintain the COT.

For instance, the characteristic of the PSFCH may include what the order is of the PSFCH associated with one PSCCH/PSSCH. For example, each PSCCH/PSSCH may have multiple PSFCH occasions to feedback the decoding of the PSCCH/PSSCH. The WTRU may be (pre-)configured with a priority offset for each order of the PSFCH (e.g., the WTRU may be (pre-)configured with one priority offset for the first PSFCH and another priority offset for the second PSFCH to feedback one PSCCH/PSSCH).

For instance, the characteristic of the PSFCH may include which transmission of a PSCCH/PSSCH the PSFCH is associated with (e.g., whether the PSFCH is associated with the initial transmission or a retransmission of a TB).

For instance, the characteristic of the PSFCH may include whether the feedback in PSFCH is ACK or NACK.

For instance, the characteristic of the PSFCH may include whether the PSFCH is used to feedback initial transmission or retransmission of a TB.

For instance, the characteristic of the PSFCH may include one or more LBT parameters to access the channel and transmit PSFCH. For example, the WTRU may be (pre-)configured with two priority offset, in which the first offset may be used for channel access with long CCA (e.g., type 1 LBT) and another offset may be used for channel access with short CCA (e.g., type 2 LBT).

For instance, the characteristic of the PSFCH may include the type of the PSFCH occasion (e.g., whether the PSFCH occasion is within the COT of the Tx WTRU, within a COT of the Rx WTRU, and/or in a (pre-)configured occasion in the resource pool).

For instance, the characteristic of the PSFCH may include the CPE used for each PSFCH. For example, the WTRU may be (pre-)configured to have higher priority offset for a PSFCH with a longer (pre-)configured CPE.

For instance, the characteristic of the PSFCH may include a bandwidth of the PSFCH (e.g., whether it is a single-channel or multi-channel PSFCH) and/or bandwidth of the associated PSCCH/PSSCH. For example, the WTRU may be (pre-)configured with one or more priority offset in which one priority offset may be associated with one bandwidth of the PSFCH and/or the associated PSCCH/PSSCH. The WTRU may then determine the priority of the PSFCH based on the bandwidth of the PSFCH and/or associated PSCCH/PSSCH and the priority of the PSCCH/PSSCH.

In one case, a WTRU may determine whether to apply a priority offset for each PSFCH. The WTRU may determine whether to apply a priority offset to determine the priority of a PSFCH based on one or more of the following: the WTRU performs prioritization between two PSFCHs having the same priority of the associated PSCCH/PSSCH; and/or, the type of the PSFCH occasion (e.g., whether the PSFCH occasion is within the COT of the Tx WTRU, within a COT of the Rx WTRU, and/or in a (pre-)configured occasion in the resource pool) (e.g., the WTRU may apply the priority offset for the PSFCH within a COT; otherwise, if PSFCH is outside of a COT, the WTRU may not apply priority offset).

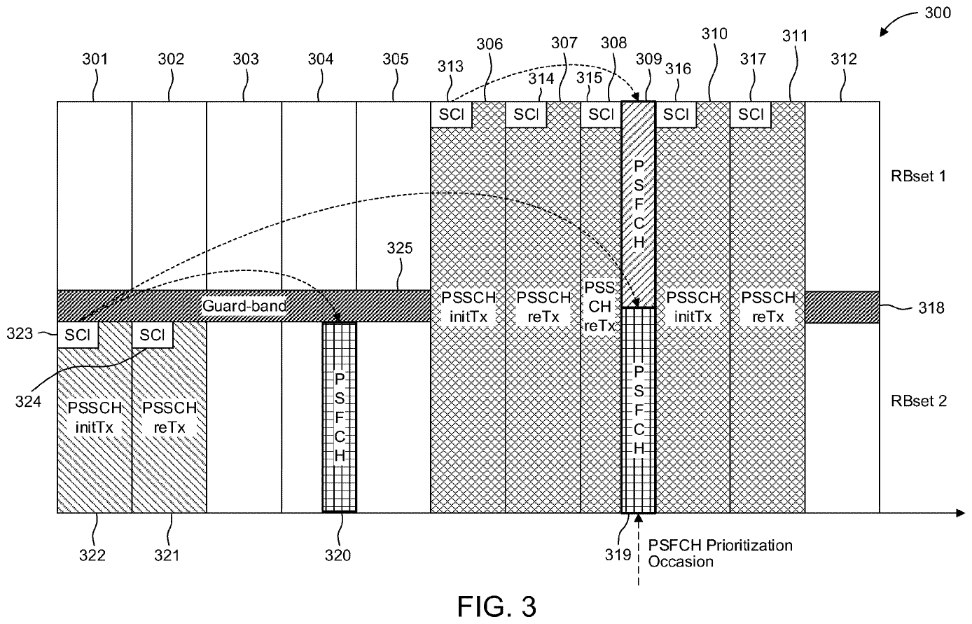

FIG. 3 illustrates an example of PSFCH prioritization. As shown, time is on the horizontal axis and frequency is on the vertical axis; for the example shown, there may be a scenario where a first WTRU performs at least a sending of a message and a second WTRU performs at least receiving the message and sending of feedback. As can be understood from the figure, the first WTRU may send one or more transmissions (e.g., 322 initial transmission, 321 retransmission, 306 initial transmission, 314 retransmission, 308 retransmission (partial), 310 initial transmission, 311 retransmission, etc.) which may or may not have SCI. In this example, the second WTRU may determine to perform PSFCH prioritization (e.g., if it is needed, triggered, configured, etc.). The second WTRU may perform PSFCH prioritization (e.g., after it determines the priority and whether to apply it, etc.), which may include the prioritization between PSFCH transmission and reception in the same slot and prioritization among PSFCH transmissions in the same slot. In case the second WTRU needs to transmit and/or receives simultaneously multiple PSFCHs and it could not perform such simultaneous transmission and/or reception, the second WTRU may then prioritize the PSFCHs with higher priority.

As shown in the example of FIG. 3, the second WTRU may need to transmit two PSFCH in one slot (e.g., 309 and 319). The second WTRU may then determine to transmit only one PSFCH (e.g., either 309 or 319). The WTRU may then prioritize the PSFCH to feedback to the COT initiator first WTRU to support the first WTRU in maintaining the COT and continue transmission after the PSFCH occasion (e.g., 310 and 311). In the example shown, the second WTRU may determine to send a PSFCH transmission for a received PSSCH transmission (e.g., 322) at 319, and does not send, or cannot send, or the PSFCH is not successful, at 320 (e.g., medium access assessment, like CCA and/or LBT, indicates sending a transmission is not possible/allowed).

For unlicensed operation, channel occupancy time (COT) sharing between two WTRUs may be supported, in which the WTRU can continue using the COT of another WTRU to transmit PSFCH and/or PSCCH/PSSCH. To maintain a multi-channel COT, WTRUs involved in the COT maintenance may need to contiguously transmit signals in all RB-sets during the COT duration. The maximum allowable interruption time between two transmissions may be preconfigured value (e.g., 25 us). Accordingly, it may be necessary for a WTRU to transmit a signal (e.g., as described herein) to maintain a COT.

Regarding S-SSB(s), S-SSB occasion(s) may be (pre-)configured in a resource pool. The WTRU may be required to perform LBT before transmission of S-SSB. If the WTRU transmits S-SSB(s) only, it may need to perform LBT. However, when the WTRU initiates a COT, the COT may be maintained by transmitting S-SSB(s) or any other type of transmission.

A WTRU may be (pre-)configured with two set of S-SSB occasions, in which one set of occasions (e.g., S-SSBs) is excluded from any resource pool. The remaining S-SSB occasions (e.g., S-SSBs) may or may not be excluded from a resource pool.

In unlicensed sidelink operation, S-SSB and/or PSFCH may be used for control signals, which may help the sidelink system operate properly and efficiently. For example (e.g., in wideband operation, or other situations), it may be important to access the channel and transmit control signals such as S-SSB(s) and/or PSFCH to support the system using unlicensed spectrum efficiently and fairly. Accordingly, there is a need for one or more procedures/devices/systems for control signal transmissions including PSFCH and/or S-SSB in multi-channel operation in sidelink unlicensed operation. As described herein, multi-channel PSFCH may be used to describe the case that the WTRU provides feedback to a PSCCH/PSSCH using multiple channels. In one solution, the WTRU may transmit one PSFCH in one channel and repeat the same feedback in other channels. In another solution, the WTRU may transmit one PSFCH spanning over multiple channels. From this example of PSFCH control signaling, it may be understood that when using multi-channel techniques, a transmission may be repeated in other channels; additionally/alternatively, it may be understood that when using multi-channel techniques, a transmission may be span other channels. Accordingly, using multi-channel for synchronization (e.g., S-SSB, which is also control signaling), may also involve repeating the transmission in other channels, and/or breaking the transmission up to span other channels, as further described herein.

In some cases, there may be one or more methods for multi-channel synchronization. In one case, a WTRU may determine a set of parameters to access one or more channel(s) and send S-SSB(s) and/or PSSCH/PSSCH transmission(s). A WTRU may determine to transmit S-SSB(s) and/or PSCCH/PSSCH(s) using one or more parameters (e.g., a set, configured or determined, as further described herein). A set of parameters to access channel(s) and transmit S-SSB(s) and/or PSCCH/PSSCH transmission(s) may include one or more (e.g., a combination) of the following: a set of RB-sets to transmit S-SSB(s); whether S-SSB(s) is transmitted using multi-channel(s) (e.g., multiple channels, multiple RB(s), multiple RB sets, etc.) or a single-channel (e.g., one channel, one RB, one RB set, etc.); a Clear Channel Access (CCA) duration; a LBT type for each RB-set and/or all RB-sets to transmit S-SSB; a LBT type for multi-channel access (e.g., LBT type A, A1, A2, B, B1, B2); whether a WTRU performs short CCA for each RB-set (e.g., LBT type 2-like channel access procedure) or it performs long CCA (e.g., LBT type 1-like channel access procedure); a LBT type for one LBT RB-set channel access (e.g., LBT type 1, 2, 2A, 2B, 2C); priority information (e.g., a channel access priority class (CAPC); contention window size, which may include the current contention window (CWₚ), the minimum, and/or the maximum contention window associated with a channel access priority class p (e.g., CWₚ, CW_{min,p}, and CW_{max,p}); a defer period (T_{d}); a LBT energy detection threshold to determine the availability of a channel; and/or, transmission power of S-SSB. As described herein, channel, RB-set, and LBT sub-band may be used interchangeably. As described herein, short CCA may be used to describe any LBT scheme, which requires the WTRU to perform short sensing of the channel before transmission. Such short CCA may be used for the WTRU to share a COT or to transmit a short control signaling. Examples of short CCA may be any LBT type 2 schemes, such as LBT type 2A, LBT type 2B, and LBT type 2C. As described herein, Long CCA may be used to describe any LBT scheme, which requires the WTRU to perform a longer sensing, which may be required for the WTRU to initiate a COT. Example of long CCA may be any LBT type 1 scheme.

In one case, a WTRU may determine (e.g., be configured, satisfies a condition, etc.) the parameters to access the channel and transmit S-SSB(s). In one approach, a WTRU (e.g., Rx WTRU) may determine one or more parameters to access the channel and transmit one or more S-SSB(s) in one S-SSB occasion. One or more parameters in a given set of parameters being used to access a channel and transmit S-SSB(s) may be determined based on one or more conditions/factors (e.g., any conditions/factors described herein). From the aforementioned, it may be understood that one or more S-SSB may be transmitted in one occasion, or more than one occasion (e.g., where the same parameter(s) and/or conditions/factors apply), or where one occasion allows for sending S-SSB(s) using a multi-channel/RB set approach. Further, it may be understood from the aforementioned, and/or other related descriptions herein, that one or more parameters (e.g., whether single or multi-channel S-SSB(s) transmissions is used) in a given set of parameters being used to access a channel and transmit S-SSB(s) may be determined based on one or more conditions/factors (e.g., such as those conditions/factors described herein). For example, a WTRU may determine to send S-SSB(s) using single-channel or multi-channel based on one or more factors (e.g., more than one RB set, that is contiguous, non-contiguous, adjacent, non-adjacent, configured, determined based on one or more factors, etc.); based on that one or more factors, the WTRU may determine to send S-SSB using multi-channel; the WTRU may or may not also perform a CCA or LBT prior to sending S-SSB(s); the WTRU may or may not perform a control channel transmission and/or a data transmission prior to sending S-SSB(s); the one or more factors may relate to a COT (e.g., as further described herein). In one instance, multi-channel S-SSB may be determined on whether a threshold has been met, crossed, or the like, as it relates to a COT (e.g., a threshold time for a COT, or data to be transmitted in a COT, etc.) For instance, one or more parameter(s) may be based on the buffer status of the WTRU. In one example, if the buffer status of the WTRU is greater than a (pre-)configured threshold, the WTRU may initiate a COT to transmit multi-channel S-SSB. The WTRU may then continue using the COT to transmit multi-channel PSCCH/PSSCH. The WTRU may determine the parameters to perform LBT based on the QoS (e.g., priority, latency, reliability, minimum communication range, remaining PDB) of the data in the buffer. Otherwise, if the buffer status of the WTRU is smaller than the threshold, the WTRU may initiate a COT to transmit single-channel S-SSB. The WTRU may then continue to transmit PSCCH/PSSCH using single-channel. From the aforementioned example, it may be understood that the amount of data to be transmitted and/or the QoS of the date to be transmitted may be factors in determining parameters (e.g., single or multi-channel, or other parameters described herein).

For instance, one or more parameter(s) may be based on a set of acquired RB-sets to transmit PSCCH/PSSCH before the S-SSB occasion. For example, the WTRU may first initiate a COT to transmit data. The WTRU may then continue S-SSB in the COT. The set of RB-sets used to transmit S-SSB may be the same as the set of RB-sets used to transmit PSCCH/PSSCH. From this example, it may be understood that one factor that is used in determining one or more factors for transmissions (e.g., channel access, S-SSB(s), data, control, etc.) may be based on RB-sets; it may also be understood that one factor that is used in determining one or more factors for transmissions (e.g., channel access, S-SSB(s), data, control, etc.) may be based on COTs (e.g., whether they have started, whether they need to be continued, a time threshold related to the COT, etc.).

For instance, one or more parameter(s) may be based on the result of the LBT procedure to transmit one or more S-SSB(s). For example, the WTRU may be (pre-)configured to perform LBT (e.g., LBT generally, or LBT of a specific type disclosed herein, or some other form of medium assessment) in a set of RB-sets (e.g., all RB-sets in the resource pool). The WTRU may then transmit one or more S-SSB(s) in the set of RB-sets if LBT is successful. Otherwise, if the WTRU fails LBT in one of the RB-sets, the WTRU may transmit one or more S-SSB(s) in one RB-set with lowest/highest RB-set index or in a set of contiguous LBT succeed RB-sets.

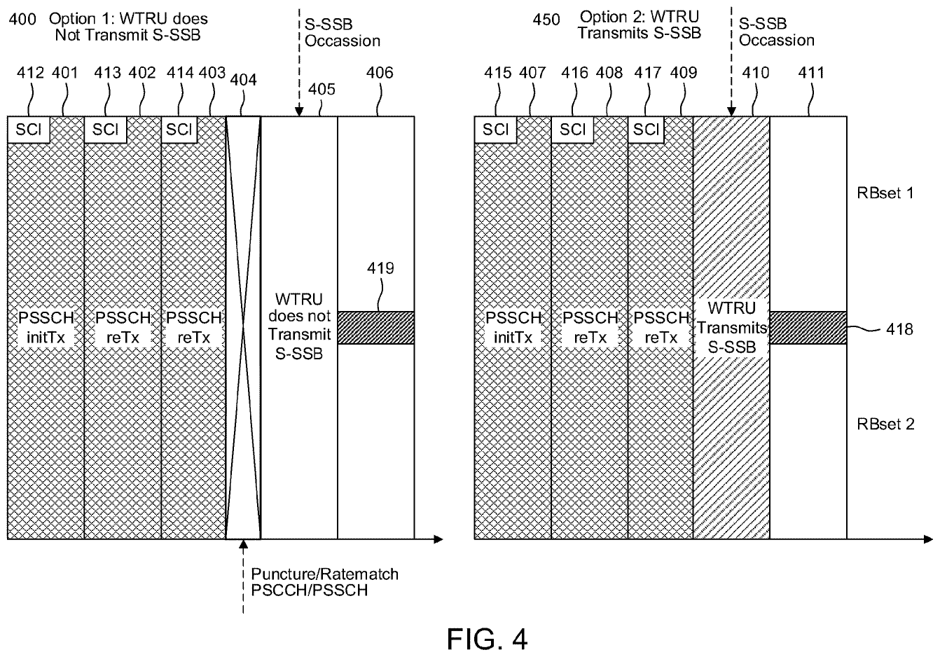

FIG. 4 illustrates an example of a WTRU determining to send a sidelink synchronization signal block (S-SSB). In the FIG. 4, time is shown on the horizontal axis and frequency is shown on the vertical axis; for example, there may be time increments (e.g., slots, or otherwise as described herein) in which one or more WTRUs use as transmission/reception opportunities; additionally, there may be one or more sets (e.g., of one or more) of frequency/bandwidths/resource blocks (e.g., contiguous, non-contiguous, etc.) that the WTRU can use to transmit/receive in a given time increment (e.g., at some point in time during the time increment, such as the start, middle, end, etc., as required or configured, etc.); additionally, there may be a guard band between two or more RB set (e.g., 419 at 406, and/or 418 at 411). From the figure, it may be generally understood that a WTRU may send an initial transmission (e.g., 401 or 407), and may transmit zero or more retransmissions (e.g., 402, 403, or 408, 409). SCI may be sent at a time increment before or at the same time, and/or in a part of a RB set(s), for any of the (re)transmission(s). FIG. 4 illustrates several different features, as described herein. One feature that can be better understood from the illustration is that a Tx WTRU may send a S-SSB to one or more Rx WTRUs. The Tx WTRU may send one or more S-SSBs in one or more time increments and/or in one or more RB sets. Another feature that may be understood from the figure is determining whether to puncture/rate-match a PSCCH/PSSCH based on whether it transmits one or more S-SSB. In one case, a WTRU may determine whether to puncture/rate-match in one PSCCH/PSSCH transmission before on S-SSB, as further described herein.

In one approach, the WTRU may initiate a COT for data transmission. The COT may include one or more S-SSB occasions (e.g., 405 and 410). The WTRU may then determine whether to puncture/rate-match one PSCCH/PSSCH transmission before the S-SSB based on whether the WTRU transmits an S-SSB. Specifically, if the WTRU transmits S-SSB, the WTRU may not puncture/rate-match the transmission of PSCCH/PSSCH in the slot before S-SSB. Otherwise, if the WTRU does not transmit S-SSB, the WTRU may puncture/rate-match a period before an S-SSB occasion. The WTRU may indicate whether the WTRU will puncture/rate-match, and/or the information about the punctured/rate-matched duration in one or more of the SCI (e.g., 412, 413, 414, 415, 416, 417) of the associated PSCCH/PSSCH (e.g., 401, 402, 403, 407, 408, 409).

In one example shown in FIG. 4, in Option 1 at 400, the WTRU does not transmit S-SSB, so that the WTRU determines to puncture/rate-match the PSCCH/PSSCH transmission in a duration at 404 before the S-SSB occasion at 405. In one example shown in FIG. 4, in Option 2 at 450, the WTRU may determine to transmit S-SSB at 410; in one instance, the WTRU may not puncture/rate-match in the duration before the S-SSB occasion.

As described herein, there may be an instance where a WTRU may need to send a S-SSB (e.g., synchronization reasons, configuration information reasons, COT reasons, or the like as described herein). In an example, there may be multi-channel operation for S-SSB. The WTRU may determine whether to access the channel to transmit S-SSB in one S-SSB occasion, whether to transmit multi-channel S-SSB, and/or the LBT parameters to assess the channel based on one or more factors (e.g., the buffer status of the WTRU, and the QoS of the data in the buffer, or other factors described herein). The WTRU may be (pre-)configured with a minimum data threshold to transmit data in multi-channel. The WTRU may determine to transmit S-SSB in a sync period (e.g., to become SyncRef WTRU). The WTRU may determine the parameters to access the channel and transmit S-SSB based on one or more factors (e.g., the amount of data in the buffer and the QoS of the data, or other factors described herein). If the WTRU does not have data to transmit (e.g., where the WTRU would have already been accessing the channel, and would have performed a LBT/CCA and send a data/control transmission), the WTRU may perform short CCA (e.g., type 2 LBT) to access the channel and transmit S-SSB in a (pre-)configured RB sets. If an amount of data is larger than the (pre-)configured threshold, then the WTRU may perform one or more of the following: determine long CCA (e.g., type 1 LBT parameters, CAPC, CW) to access the multi-channel channel based on QoS of the data in the buffer; perform multi-channel S-SSB transmission if LBT is successful; and/or, continue transmitting multi-channel PSCCH/PSSCH in subsequent slots. If an amount of data is smaller than the (pre-)configured threshold, then the WTRU may perform one or more of the following: determine long CCA (e.g., type 1 LBT parameters, CAPC, CW) to access the single-channel channel based on QoS of the data in the buffer; perform single-channel S-SSB transmission if LBT is successful; and/or, continue transmitting single-channel PSCCH/PSSCH in subsequent slots. Sending an S-SSB may help maintain a COT. Using single channel or multi-channel S-SSB may be based on one or more factors disclosed herein (e.g., COT, RB set, etc.). Using multi-channel transmission may repeat the transmission of an S-SSB. RB set(s) for multi-channel may be configured and/or determined based on one or more factors, as described herein.

In an example, there may be multi-channel operation for S-SSB. The WTRU may determine whether to access the channel to transmit S-SSB in one S-SSB occasion, whether to transmit multi-channel S-SSB, and/or the LBT parameters to assess the channel based on the buffer status of the WTRU, and the QoS of the data in the buffer. The WTRU may be (pre-)configured with the minimum data threshold to transmit data in multi-channel. The WTRU may determine to transmit S-SSB in a sync period (e.g., to become SyncRef WTRU). The WTRU may determine the parameters to access the channel and transmit S-SSB based on the amount of data in the buffer and the QoS of the data. If the WTRU does not have data to transmit, the WTRU may perform short CCA (e.g., type 2 LBT) to access the channel and transmit S-SSB in a (pre-)configured RB sets. If the amount of data is larger than the (pre-)configured threshold, then the WTRU may perform one or more of the following: determine long CCA (e.g., type 1 LBT parameters, CAPC, CW) to access the multi-channel channel based on QoS of the data in the buffer; perform multi-channel S-SSB transmission if LBT is successful; and/or, continue transmitting multi-channel PSCCH/PSSCH in subsequent slots. If the amount of data is smaller than the (pre-)configured threshold, then the WTRU may perform one or more of the following: determine long CCA (e.g., type 1 LBT parameters, CAPC, CW) to access the single-channel channel based on QoS of the data in the buffer; perform single-channel S-SSB transmission if LBT is successful; and/or, continue transmitting single-channel PSCCH/PSSCH in subsequent slots.

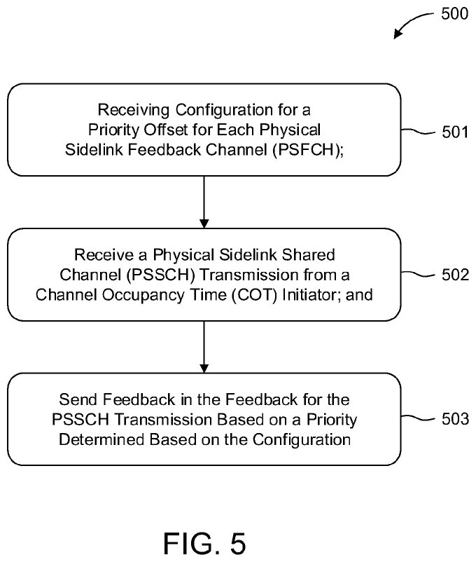

FIG. 5 illustrates an example of one or more techniques described herein. At 501, a WTRU may receive configuration for a priority offset for each physical sidelink channel (PSFCH). At 502, the WTRU may receive a physical sidelink channel transmission (PSSCH) from a channel occupancy time (COT) initiator. At 503, the WTRU may send feedback for the PSSCH transmission based on a priority determined based on the configuration.

In an example, there may be PSFCH prioritization. A WTRU may determine the priority of each PSFCH based on the QoS of the TB, whether it is used to feedback to the initiator of the current COT, the order of the PSFCH occasion, and/or the transmission bandwidth of the associated TB. The WTRU may then perform prioritization among multiple PSFCHs based on the priority of each PSFCH. The WTRU may be (pre-)configured with the priority offset for each PSFCH characteristic. The WTRU may determine the priority of each PSFCH based on the priority of the associated PSCCH/PSSCH and the (pre-)configured offset. For instance, in addition to the priority of the associated TB, the WTRU can be configured one offset for PSFCH feedback for the COT initiator, another offset for PSFCH in the second order, and/or another offset for PSFCH of multi-channel TB. The WTRU performs PSFCH prioritization based on the priority of each PSFCH if the WTRU cannot transmit multiple PSFCHs simultaneously.

In an example, a WTRU determines the parameters of its COT. In an example, a WTRU determines the type of PSFCH occasions to transmit feedback. In an example, a WTRU determines one or more parameters in the set of parameters to access the channel and Tx PSFCH. In an example, a WTRU determines the parameters in the set of parameters to access the channel and transmit PSFCH. In an example, a Tx WTRU indicates multiple PSFCH occasions to feedback a PSCCH/PSSCH. In an example, a WTRU determines the parameters to access the channel and transmit feedback for retransmission of a TB. In an example, a WTRU determines the parameters to access the channel and transmit feedback for another TB. In an example, a WTRU determines the priority of each PSFCH based on the characteristic of the PSFCH. In an example, a WTRU determines the set of parameters to access the channel and transmit S-SSB and/or PSCCH/PSSCH. In an example, a WTRU determines the parameters to access the channel and transmit S-SSB. In an example, a WTRU determines whether to puncture/rate-match in one PSCCH/PSSCH transmission before one S-SSB.

As described herein, a higher layer may refer to one or more layers in a protocol stack, or a specific sublayer within the protocol stack. The protocol stack may comprise of one or more layers in a WTRU or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non-Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Although features and elements are described above in particular combinations (e.g., embodiments, methods, examples, etc.), one of ordinary skill in the art will appreciate that each feature or element can be used alone or in any combination with the other features and elements. For example, as disclosed herein there may be a method described in association with a figure for illustrative purposes, and one of ordinary skill in the art will appreciate that one or more features or elements from this method may be used alone or in combination with one or more features from another method described elsewhere. A symbol ‘/’ (e.g., forward slash) may be used herein to represent ‘and/or’, where for example, ‘A/B’ may imply ‘A and/or B’. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use by a first wireless transmit receive unit (WTRU), the method comprising:
receiving configuration information related to one or more physical sidelink feedback channels (PSFCH);
receiving one or more physical sidelink shared channel (PSSCH) transmissions from one or more second WTRUs, wherein the one or more second WTRUs initiated a channel occupancy time (COT); and
sending a physical sidelink feedback channel (PSFCH) transmission for at least one PSSCH transmission of the one or more PSSCH transmissions based on a priority determined from the configuration information, wherein the PSFCH transmission is prioritized over other PSFCH transmissions based on the determined priority.

2. The method of claim 1, wherein the priority is based on an indication sent from the one or more second WTRUS.

3. The method of claim 1, wherein the priority is based on which WTRU sent the at least one PSSCH transmission.

4. The method of claim 1, wherein the priority is based on a quality of service parameter of a transport block sent in the one or more PSSCH transmissions.

5. The method of claim 1, wherein multi-channel operation is used to send the one or more PSFCH transmissions as a result of the at least one PSSCH transmission indicating multi-channel.

6. The method of claim 1, wherein the configuration information includes an offset associated with a priority.

7. The method of claim 1, wherein the priority is based on an order of a PSFCH occasion.

8. A first wireless transmit receive unit (WTRU) comprising:
a processor operatively coupled to a transceiver, the processor and transceiver configured to receive configuration information related to one or more physical sidelink feedback channels (PSFCH);
the processor and transceiver configured to receive one or more physical sidelink shared channel (PSSCH) transmissions from one or more second WTRUs, wherein the one or more second WTRUs initiated a channel occupancy time (COT); and
the processor and transceiver configured to send a physical sidelink feedback channel (PSFCH) transmission for at least one PSSCH transmission of the one or more PSSCH transmissions based on a priority determined from the configuration information, wherein the PSFCH transmission is prioritized over other PSFCH transmissions based on the determined priority.

9. The WTRU of claim 8, wherein the priority is based on an indication sent from the one or more second WTRUS.

10. The WTRU of claim 8, wherein the priority is based on which WTRU sent the at least one PSSCH transmission.

11. The WTRU of claim 8, wherein the priority is based on a quality of service parameter of a transport block sent in the one or more PSSCH transmissions.

12. The WTRU of claim 8, wherein multi-channel operation is used to send the one or more PSFCH transmissions as a result of the at least one PSSCH transmission indicating multi-channel.

13. The WTRU of claim 8, wherein the configuration information includes an offset associated with a priority.

14. The WTRU of claim 8, wherein the priority is based on an order of a PSFCH occasion.
